(19) United States
(12) Patent Application Publication
(10) Pub. No.: US 2026/0087309 A1
(43) Pub. Date: Mar. 26, 2026

(54) DISTRIBUTED LLM FRAMEWORK ECOSYSTEM

(71) Applicant: Dell Products L.P., Round Rock, TX (US)

(72) Inventors: Denis Solodovnikov, Ottawa (CA); Eric L. Caron, Ottawa (CA); Vinicius Michel Gottin, Rio de Janeiro (BR)

(21) Appl. No.: 18/895,896

(22) Filed: Sep. 25, 2024

(51) Int. Cl. G06N 3/045; G06N 3/0475

(52) U.S. Cl. CPC G06N 3/045; G06N 3/0475

(57) ABSTRACT

A classifier receives a user query at an edge device. The persistent storage of the edge device includes a library of context-specific LLMs. Each context-specific LLM in the library is respectively trained on only a single corresponding context. The classifier determines a context of the user query by semantically analyzing the user query. Based on the context, the classifier identifies a context-specific LLM within the library. This context-specific LLM is trained to answer queries having contexts that are the same as the context of the user query. The classifier loads the context-specific LLM into memory of the edge device and then causes the context-specific LLM to generate an answer to the user query.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to improved usage of large language models (LLMs). More particularly, at least some embodiments relate to systems, hardware, software, computer-readable media, and methods for implementing modular, context-specific LLMs in edge devices of a network in a manner so as to achieve performance that is similar to large scale LLMs implemented in a cloud environment.

### BACKGROUND

Artificial intelligence (AI) is one of the fastest-growing technologies in the world and will likely continue to grow. AI is being introduced in almost all aspects of human life. With AI being more generally available (both proprietary and open source) and with significant effort being spent to train AI models, AI can often now be utilized to perform tasks faster than a human can. Utilizing AI can boost human productivity by offloading time-consuming tasks.

Many software vendors are releasing new AI technology to consumers. Microsoft ChatGPT-X, a proprietary cloud-based AI, is being commercialized and is being added to Microsoft products. Meta's Llama-X LLM has become a go-to model for many open-source projects. HuggingFace has published thousands of LLMs that attempt to achieve specific LLM performance and accuracy criteria.

Graphics processing units (GPUs) are often used for faster LLM performance. Cloud-based offerings utilize large clusters of expensive GPU clusters to run large LLMs. Running LLMs locally is in the infancy stage, where advanced LLMs are getting so large that no current consumer GPU card can solely run them. Hardware vendors are racing to “first to market” neural processing units (NPUs) that allow consumer devices to run larger LLMs locally. However, while these NPUs offer some performance improvement, they cannot load LLMs currently hosted on cloud GPU clusters from large vendors. Additionally, as LLMs become larger, it becomes a constant race for consumer NPUs to catch up to advanced AI LLM sizes.

Many companies are considering introducing LLMs into their workflows. One primary concern is the privacy of proprietary commercial data sent to cloud-based LLMs. Many companies prefer running LLMs locally to protect them from leaking proprietary commercial data. However, as few companies can afford to build a private, large GPU cluster required to run advanced LLMs, many are leaning towards cloud-based offerings, usually on a “vendor trust” basis.

Effectively, consumer, edge, or even mobile devices are being “forced” to use cloud AI offerings, as no other options (or very limited options) are currently available to achieve the same level of performance on local hardware. Many AI experts predict that cloud-based AI will be the industry's future; however, there is a strong demand for AI-capable edge devices that are not connected to the cloud and that operate with AI capabilities. While cloud-based AI can jumpstart the introduction of AI (e.g., LLMs) into the lives of the general population, running AI locally without a constant cloud connection is one hurdle to broader acceptance of AI at the individual consumer level.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example computing architecture for implementing modular, context-specific LLMs at edge devices.

FIG. 2 discloses aspects of a process flow for implementing a context-specific LLM.

FIG. 3 illustrates additional aspects of implementing the context-specific LLM.

FIG. 4 illustrates additional aspects of implementing the context-specific LLM.

FIG. 5 illustrates additional aspects of implementing the context-specific LLM.

FIG. 6 illustrates additional aspects of implementing the context-specific LLM.

FIG. 7 illustrates additional aspects of implementing the context-specific LLM.

FIG. 8 illustrates additional aspects of an example method for implementing the context-specific LLM.

FIG. 9 illustrates aspects of an example computer system that can be configured to perform any of the disclosed operations.

### DETAILED DESCRIPTION

As LLMs increase their capabilities, their size and compute requirements increase significantly. Few consumer devices can run large LLMs due to significant GPU and memory requirements needed to load the model. Larger, more advanced LLMs will likely be deployed in the cloud due to significant infrastructure and GPU costs.

Historically, there has not been a viable way to obtain the capabilities of more significant or “advanced” LLMs on consumer/edge devices due to hardware and cost constraints. Consumer hardware constantly races to catch up to cloud capabilities for running large-scale LLM AI on local hardware. Evolving cloud hardware capable of running more prominent and larger models will likely always be ahead of consumer hardware. A different LLM AI approach is thus needed to allow matching AI capabilities on local devices.

The disclosed embodiments beneficially solve these problems and provide solutions these needs. Furthermore, the disclosed embodiments bring about numerous benefits, advantages, and practical applications to how AI models, and in particular LLMs, are implemented at a network's edge. By way of example, the disclosed embodiments present the use of so-called “modular” and “context-specific” LLMs that are structured to enable context switches and that allow for achieving advanced AI functionality at the edge. This edge functionality can now closely match cloud-based large AI LLM functionality while using lower hardware requirements. Thus, edge devices can now operate in a manner that closely resembles the large scale infrastructure of a cloud environment in terms of how LLMs are implemented.

Additionally, the disclosed modular LLM approach allows a path for implementing a hybrid AI approach with on-device and cloud-based LLMs. Current LLM sources and repositories lack a structured approach that complicates or prevents wider AI adoption in consumer or enterprise adoption. Providing a standard framework for modular LLMs can benefit customers and can allow the “data privacy” issue mentioned earlier to be addressed, as the proprietary LLM can now be hosted locally. Thus, the disclosed embodiments are directed to techniques that allow consumer/edge devices to have advanced AI capabilities on consumer-grade devices.

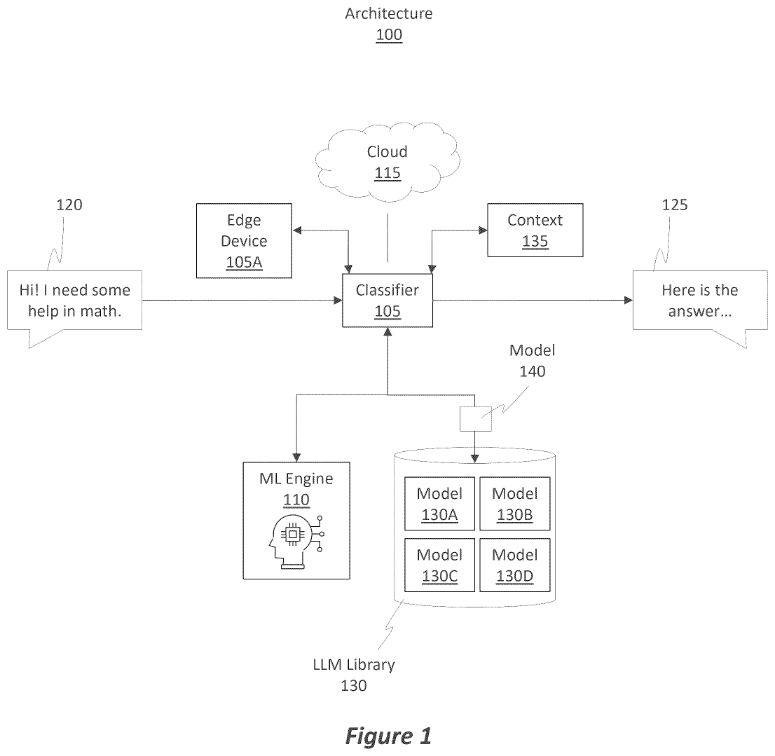

Having just described some of the various advantages provided by the disclosed embodiments, attention will now be directed to FIG. 1, which illustrates an example architecture 100 in which the disclosed principles may be employed. Architecture 100 shows a classifier 105, which may include an LLM.

As used herein, the term “classifier” (aka “service”) refers to an automated program that is tasked with performing different actions based on input. In some cases, classifier 105 can be a deterministic classifier that operates fully given a set of inputs and without a randomization factor. In other cases, classifier 105 can be or can include a machine learning (ML) or artificial intelligence engine, such as ML engine 110. The ML engine 110 enables classifier 105 to operate even when faced with a randomization factor.

As used herein, reference to any type of machine learning or artificial intelligence (or LLM) may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, classifier 105 is a local classifier operating on a local device, such as an edge device 105A. In some implementations, classifier 105 is a cloud classifier operating in a cloud 115 environment. In some implementations, classifier 105 is a hybrid classifier that includes a cloud component operating in the cloud 115 and a local component operating on a local device. These two components can communicate with one another. It is typically the case, however, that classifier 105 is executing on an edge consumer device.

Classifier 105 is generally tasked with accessing a query 120 from a user. In the example shown in FIG. 1, the query 120 includes a question from a user, where the question is as follows: “Hi! I need some help in math.” Classifier 105 is tasked with providing an answer 125 to that query 120. In this example, the answer 125 includes an appropriate and relevant response to the user's question.

To generate the answer 125, classifier 105 implements the modular LLM approach that was introduced above. Generally, classifier 105 accesses an LLM library 130 that is stored in persistent, non-volatile storage of the local edge device. The LLM library 130 includes a set of modular, context-specific LLMs that are each respectively trained on a single, specific context or area of focus, as shown by models 130A, 130B, 130C, and 130D. By “context,” it is generally meant that the modular models are trained on a specific topic and are able to answer queries related to that topic but that are likely not able to answer queries related to other topics. Thus, the modular, context-specific LLMs in the LLM library 130 are limited models in that they are context-specific LLMs as opposed to being a general purpose LLM. By way of an example, the model 130A may be trained only on math-related topics while the model 130B may be trained only on history-related topics. In contrast, a general purpose LLM may be trained on an almost unlimited number of different contexts or topics.

Classifier 105 initially receives the query 120 and relies on a primary classification LLM that is tasked (based on its training) with identifying a specific context 135 that is referenced or alluded to in the query 120. The LLM of classifier 105 can determine the context 135 by semantically analyzing the language in the user query 120.

In the example shown in FIG. 1, the context 135 of the query 120 is a math-related context (e.g., “I need some help in math” in the query 120 suggests the context is math related). In response to the context 135 being determined, classifier 105 will then access the LLM library 130 and search for a math-related LLM. Classifier 105 will then facilitate the loading of that math-related LLM into the edge device's memory. Thus, the math-related LLM, which was originally persistently stored in the edge device's persistent storage, is loaded into the edge device's memory. The model 140 is representative of the math-related LLM that is being loaded into memory.

After the math-related LLM is loaded into the edge device's memory, classifier 105 then provides the query 120 to the math-related LLM. The math-related LLM then operates using the query 120 to generate the answer 125.

After the answer 125 has been provided, a number of subsequent operations can optionally be performed. In one scenario, the math-based LLM is unloaded from memory (but potentially retained in the persistent storage), and the classifier (i.e. the one tasked with determining a context based on a query) has an LLM that is then tasked with addressing any new queries that are submitted by the user.

In another scenario, the math-based LLM is permitted to remain in memory until such time as a query is received and a determination is made that a new context is being implemented. At that time, a relevant LLM for that new context can be loaded into memory after the math-based LLM is unloaded.

In another scenario, the classifier is unloaded from memory when the context specific LLM (e.g., the math-based LLM in the above example) is selected for loading into memory. Thus, in some scenarios, only a single LLM is permitted to remain in memory at any given time. In an alternative scenario, the classifier is permitted to remain in memory while the context specific LLM is also loaded into memory. Such a configuration is possible if the edge device has sufficient memory resources to accommodate the use of two LLMs at the same time in memory. Further details on these aspects will be provided shortly.

In the scenario where the classifier is unloaded from memory, various options are available to trigger the system to reload the classifier into memory to facilitate a context switch. In one example, the user interface displaying the chat conversation can include a user interface element that, when selected, informs the system that the classifier is to be reloaded into memory because the user desires to switch contexts. Thus, after (or concurrently with) the context specific LLM is loaded into memory, the classifier can be unloaded. Subsequently, when the user wants to switch contexts, the user can select the user interface element. The selection of that user interface element will cause the classifier to be reloaded into memory. The classifier can then interact with the user to determine a new context for the conversation. In some scenarios, the user interface element can be a selectable button or a type of drop down option.

In another scenario, the reloading of the classifier can be triggered based on the detection of one or more key words or trigger words that are entered by the user and that are received at the user interface. As various examples, the key words can include, but certainly are not limited to, words or phrases such as the following: “new context,” “new topic,” “switch context,” “switch topic,” “I want to talk about a different topic,” “I have a different question,” “on another topic,” and so on. Any number of predefined words or phrases can be used to trigger the system that a context switch is desired and that the classifier is to be reloaded into memory.

Thus, it is typically the case that the classifier is caused to remain in memory to automatically detect and facilitate a context switch. The scope of the embodiments are broad, however, and scenarios in which the classifier is unloaded from memory do exist, as indicated above. Thus, various options are available to trigger the reloading of the classifier into memory.

In any event, classifier 105 implements a modular approach in how limited, or context-specific LLMs are used. In accordance with the disclosed principles, the edge device is caused to save, in persistent storage, any number of context-specific LLMs. Optionally, new context-specific LLMs can be downloaded from an external source (e.g., perhaps the cloud or perhaps from a peer-to-peer network) if the edge device does not have a desired context-specific LLM.

Classifier 105 also includes or has access to an LLM that is tasked with determining a context for a user query or prompt. The classifier receives a user query and then determines the context of that query. Classifier 105 then facilitates the loading of the relevant context-specific LLM into the edge device's memory. From there, the context-specific LLM generates a response to the user's query. Thus, the embodiments can facilitate an LLM context swap by swapping out different limited sized, or “modular,” context-specific LLMs based on the context of the user's query. By performing these operations, the embodiments enable the edge device to operate in a manner that is similar, in terms of performance, to how a large scale LLM residing in the cloud operates.

Loading a single large LLM on a consumer or edge device is impractical due to hardware requirements. A modular approach to LLMs on consumer devices is more effective and requires less GPU, NPU, and memory capabilities.

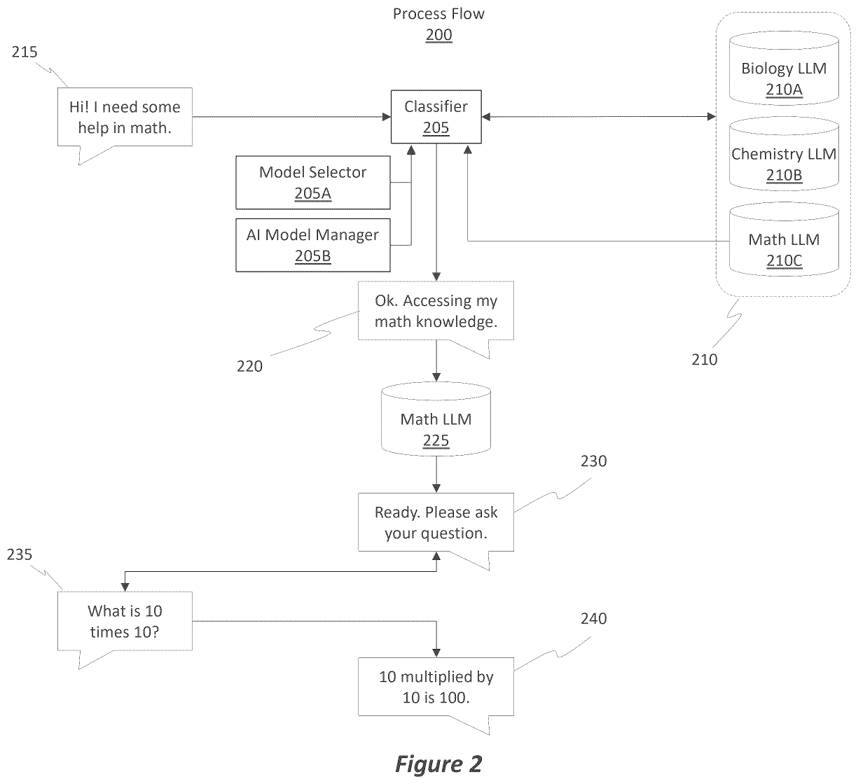

That is, rather than loading a single, large LLM that has various capabilities, the disclosed embodiments operate using split, smaller, or modular context-specific LLMs, with each being trained to address only a single specific context (e.g., a math context, a chemistry context, a history context, etc.). The embodiments dynamically and in real-time load the context-specific LLM into memory when required (thus implementing a “context switch”). In this regard, the disclosed embodiments present an architecture and approach for allowing the selective loading and unloading of specialist LLMs from public and private sources. FIG. 2 provides additional details.

FIG. 2 shows a process flow 200 that involves a classifier 205, which is representative of the classifier 105 of FIG. 1 and which can also be referred to as a “model selector” component. The “model selector” component determines the context and selects the relevant context-specific LLM. Classifier 205 can identify an appropriate context-specific LLM to load into memory based on the context identified within a user's question. For instance, classifier 205 can analyze the user input and can determine the best or most relevant context-specific LLM to use to answer that question.

As additional context-specific LLMs are created, added, or otherwise made available, updates can be performed only on the “model selector” component (hosted in the classifier 205, which is implementing a classification or context determination LLM). These focused updates can be performed to enable additional AI functionality as opposed to having to update the (potentially numerous) context-specific LLMs.

For instance, if a “medical terms and symptoms” context-specific LLM is created, the primary task LLM implemented by classifier 205 is the model that is updated to now include the ability to change to a medical topic; the context-specific LLMs need not be updated. When the user changes the question context, a new context-specific LLM is loaded, thereby reducing hardware requirements.

FIG. 2 shows a managed model repository 210, which is representative of the LLM library 130 of FIG. 1. This repository includes any number of modular and context-specific LLMs, such as the biology LLM 210A, the chemistry LLM 210B, and the math LLM 210C. Although only three are illustrated, one will appreciate how any number can be included in the edge device's persistent storage.

Repository 210 is responsible for storing context-specific LLMs, as shown in FIG. 2. In some implementations, repository 210 implements object storage, where each context-specific LLM has associated metadata tags. It is worth noting that object storage is just one example of how this can be accomplished; other solutions can be used as well. Each context-specific LLM can have a topic or context tag (e.g., such as math, finance, or cooking) and a size tag (e.g., small, medium, or large). In some implementations, the repository 210 can be hosted as a cloud instance, but it is preferable that repository 210 is hosted locally on the edge device's infrastructure.

Classifier 205 (aka a model selector 205A) can also host or include a model manager 205B. This model manager 205B can help manage user requests. One function of the model manager 205B is to initially process incoming questions and then communicate with the “model selector” 205A component to determine which topic the user's question belongs.

Once the “model selector” 205A identifies the relevant topic, the model manager 205B queries one or both of the local model repository or a central repository to locate the appropriate context-specific LLM. Sometimes, the model manager 205B can query other local clients on the same network in an attempt to identify the relevant context-specific LLM. This peer-based option will be discussed in more detail later.

In FIG. 2, classifier 205 accesses or receives the user query 215. Classifier 205 then determines the context of the user query 215. Based on that determined context, classifier 205 loads the relevant context-specific LLM into memory. Optionally, a message 220 can be provided to the user to inform the user of the loading process. Loading a context-specific LLM into memory is often a fast process (e.g., less than a few seconds, such as less than about 5 seconds). Thus, in some scenarios, instead of the message 220 being displayed, a temporary spinning wheel or some other pending indicator can be used to inform the user of the temporary delay. In this specific example, message 220 informs the user that classifier 205 is “Accessing my math knowledge.”

When the desired context-specific LLM (e.g., math LLM 225) is found, that context-specific LLM will either be loaded into memory if it is already present on the device or will be downloaded from the cloud if it is not. A remote LLM can still be queried in the cloud or enterprise infrastructure during the download process. After the context-specific LLM is downloaded or at least presented locally, it can be instantiated locally in order to answer the user's questions. For instance, FIG. 2 shows how the math LLM 225 is now loaded into memory. A notice 230 can be provided to the user to inform that user that the user can ask a context-specific question (if the user did not already). For instance, notice 230 includes the following language: “Ready. Please ask your question.” In some scenarios, the user's original question included a full description of the user's query, and the original question can simply be forwarded to the math LLM 225 without displaying the notice 230.

In the example of FIG. 2, the user then provides a query 235, which has the same context determined previously. The math LLM 225 receives the query 235 and operates based on that query 235 to produce an answer 240.

One of the benefits of the modular approach is that it reduces the time required for training or fine-tuning LLMs. Less training data is needed when training a context-specific LLM. For instance, a math LLM does not require Shakespearian literature data. Once a context-specific LLM is taught, the training data for that context-specific LLM does not need to be used for training other context-specific LLMs, thereby reducing the time required to produce a literature context-specific LLM, for example.

Dividing a large LLM into smaller, modular context-specific LLMs that are specific to different contexts enables consumer devices to access the same level of AI functionality as robust LLMs but can do so with lower hardware requirements. Although minor adjustments in how prompts are formulated may be warranted, such adjustments are not cumbersome and will actually improve the user's experience with the edge device and the LLM process. User prompts can closely resemble natural language, as the classifier discussed herein can establish a context during a conversation with the user, for example, by saying, “Can we talk about . . . ”. Anticipating a user's math question followed by a baking recipe question may seem illogical in a conversation and thus is unlikely to occur. Therefore, it is considered feasible to have a classifier that can “focus” on a specific context by loading a context-specific LLM.

The disclosed embodiments leverage the model selector (i.e. the “primary” user interaction question text classification LLM or simply the “classifier” discussed herein) to classify user questions. That classification is then used to help load a context-specific LLM into memory, thereby benefitting both memory use and response accuracy.

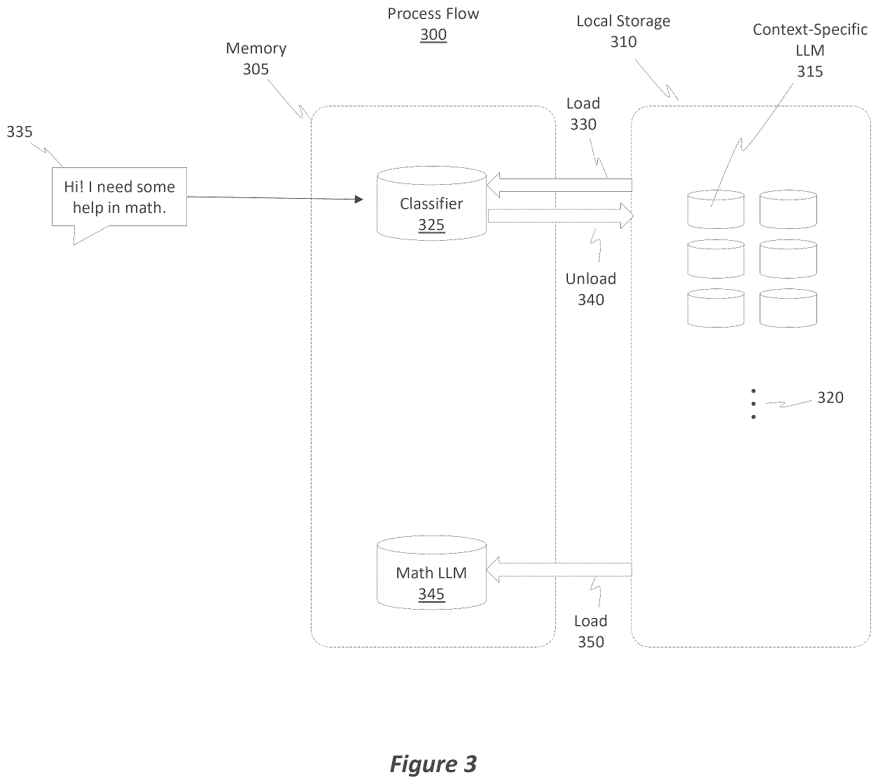

In the example below, a specific math counting and probability question is raised. The classifier determines that the user question category is math. The classifier can then be unloaded from memory, and a math-specific LLM can be loaded into memory to produce an accurate response, keeping the total memory footprint within about 4 Gb. General-purpose LLMs would likely have lower-quality answers while consuming much larger memory footprints. FIG. 3 is illustrative.

FIG. 3 shows an example process flow 300 in which an edge device includes both memory 305 and local storage 310, which is persistent storage. The local storage 310 includes any number of context-specific LLMs, such as context-specific LLM 315. The ellipsis 320 demonstrates how any number of context-specific LLMs can be saved in the local storage 310.

A classifier 325 is loaded into memory 305, as shown by load 330. A user question 335 is then received by the classifier 325 after being loaded.

After receiving the user question 335, the classifier 325 determines the context. The corresponding context-specific LLM is identified in the local storage 310. The classifier 325 is unloaded from memory 305, as shown by unload 340. The relevant context-specific model (e.g., the math LLM 345) is then loaded into memory 305, as shown by load 350. The math LLM 345 then operates on the user question 335.

In the above example, a “model selector” (hosted by the disclosed classifier) can be employed to achieve a conversation topic switch. This model selector is responsible for determining the conversation topic and for loading a context-specific LLM that is significantly smaller than the “do-it-all” LLM. The model selector can be implemented as a part of the classifier described herein. Hence, devices with lower hardware capabilities can achieve AI functionality comparable to cloud-based offerings with large LLMs, GPUs, and NPU banks.

Primary topic classification is a complex topic and can potentially have different approaches for identifying the corresponding context-specific LLM to load. One such example would be to use semantic routing approach to determine the context of the user question and the relevant context-specific LLM. In this case the overall approach of loading a context-specific LLM would still apply as the only change that would be introduced is how the context topic is being selected. Therefore, different techniques can be employed to classify a user's query so as to determine the context. For the purposes of the described examples, a classifier is used to classify the user question topic (or context) as an example of how it can be done, but other approaches are possible.

As the disclosed approach is implemented and adopted, it is envisioned that libraries of context-specific LLMs will become more available. Therefore, to introduce a “new” functionality (e.g., “cooking”), a “cooking” context-specific LLM can be downloaded from the cloud and can be included in the edge device's storage. To enable “cooking” functionality, the classifier can be fine-tuned to identify contexts focused on “cooking.” Optionally, a pre-trained classifier can be used to categorize the “topic” or “context” of the conversation first and to load the relevant context-specific LLM to continue the “topic” conversation.

While one implementation is to break LLMs up by specific topic, context, or category, as the technology is further adopted, the exact context “topic tree” can be standardized and defined to the desired level of granularity. For instance, a “cooking” context can be broken out into a “baking” context and a “BBQ” context to reduce model size for consumer devices hardware.

All tested and approved context-specific LLMs can have associated metadata with relevant information to help identify whether a given desired context-specific LLM can run on user hardware before downloading. A few different context-specific LLM sizes can also be published and offered in the library to accommodate hardware capabilities. Thus, multiple different context-specific LLMs can be generated for the same context, but those different context-specific LLMs can have different sizes to accommodate different hardware constraints.

Additionally, a library can have beta or experimental libraries or context-specific LLMs to allow end users to test the latest context-specific LLMs as they become available. User preferences or defined policies can control the ability to access beta context-specific LLMs. A managed library or ecosystem of approved context-specific LLMs with versioning can be implemented for intelligent premise downloads and can be used by the disclosed classifiers. This leads to a complete tree of knowledge with context-specific LLMs.

The “divide-and-conquer” strategy for LLMs can effectively allow a standard consumer device to answer complex topic questions with accuracy comparable to the ChatGPT-X model (or other large scale models) trained on trillion-plus parameters. It is expected that text classification prediction for a user question will not always categorize the question with 100% accuracy. For instance, given a user question with enough ambiguity or terminology in several fields, the text classification model (i.e. the classifier) may pick the highest prediction value for the classification and load the corresponding context-specific LLM to handle the request.

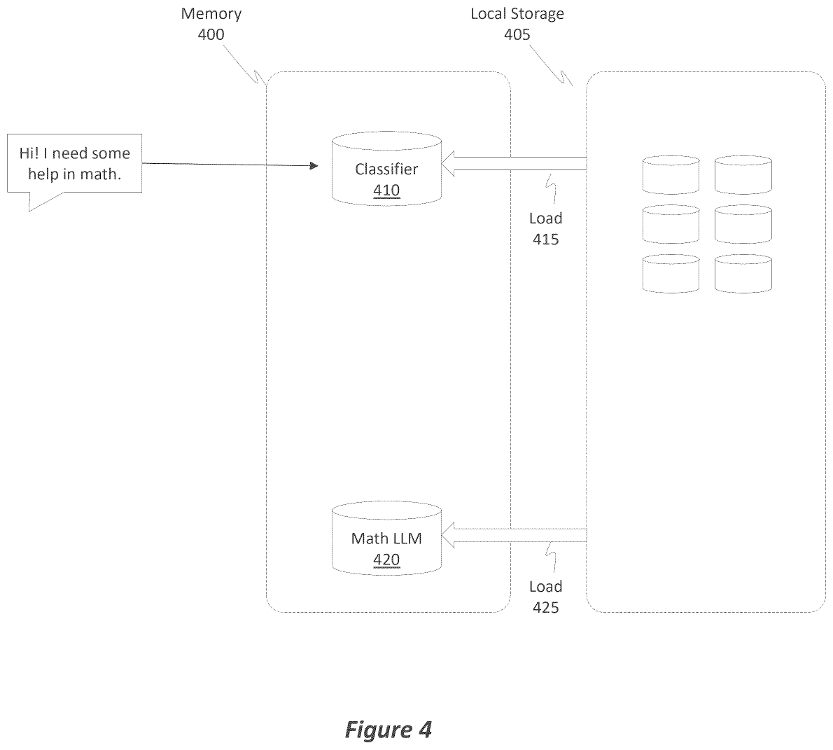

Like the disambiguation process with general LLMs, a user may be asked to introduce a clarification through prompt engineering to allow the classifier to determine the correct context for the conversation and to load the corresponding context-specific LLM. Typically, the user prompt will be expanded with additional information to allow accurate prediction and the correct context-specific LLM to be loaded.

Whereas FIG. 3 showed a scenario where the classifier was unloaded from memory to accommodate the load of the math LLM, FIG. 4 shows an alternative implementation. FIG. 4 shows memory 400 and local storage 405. Here, the classifier 410 is loaded into memory 400, as shown by load 415. The classifier 410 is caused to remain in memory 305 while the math LLM 420 is loaded into memory 400, as shown by load 425. Thus, memory 400 is sufficient to simultaneously support both the classifier 410 and the math LLM 420.

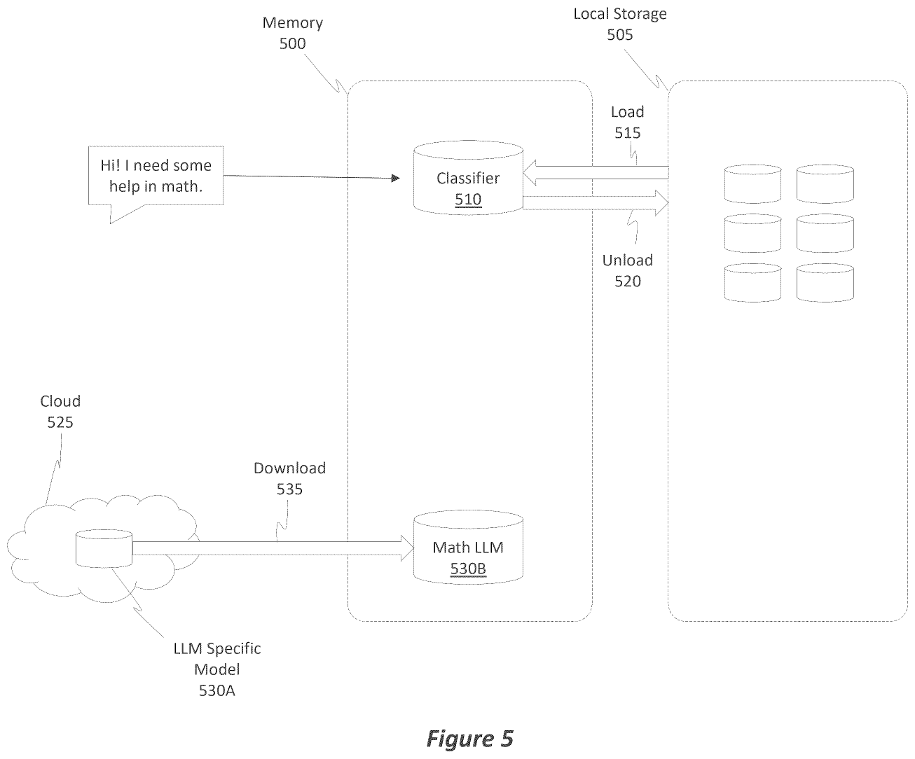

FIG. 5 shows another scenario in which a context-specific LLM is determined to not be available in the edge device's local storage, so the embodiments acquire the context-specific LLM from a cloud repository. Subsequently, that context-specific LLM can be retained in the edge device's local storage.

In particular, FIG. 5 shows memory 500 and local storage 505. A classifier 510 is loaded (e.g., load 515) into memory 500. A user question is received, and the classifier 510 determines the context of that question. The embodiments are able to determine that the local storage 505 currently does not include a context-specific LLM that is relevant to the context of the user's question. Thus, the embodiments (e.g., the disclosed classifier) can access a cloud 525. The embodiments can then identify a relevant context-specific LLM 530A that is relevant to the user's question. The embodiments download 535 that context-specific LLM and load it into memory 500, as shown by context-specific math LLM 530B. Optionally, the classifier 510 can be unloaded (e.g., unload 520) from memory 500, or it can remain in memory 500 if memory 500 has sufficient resources.

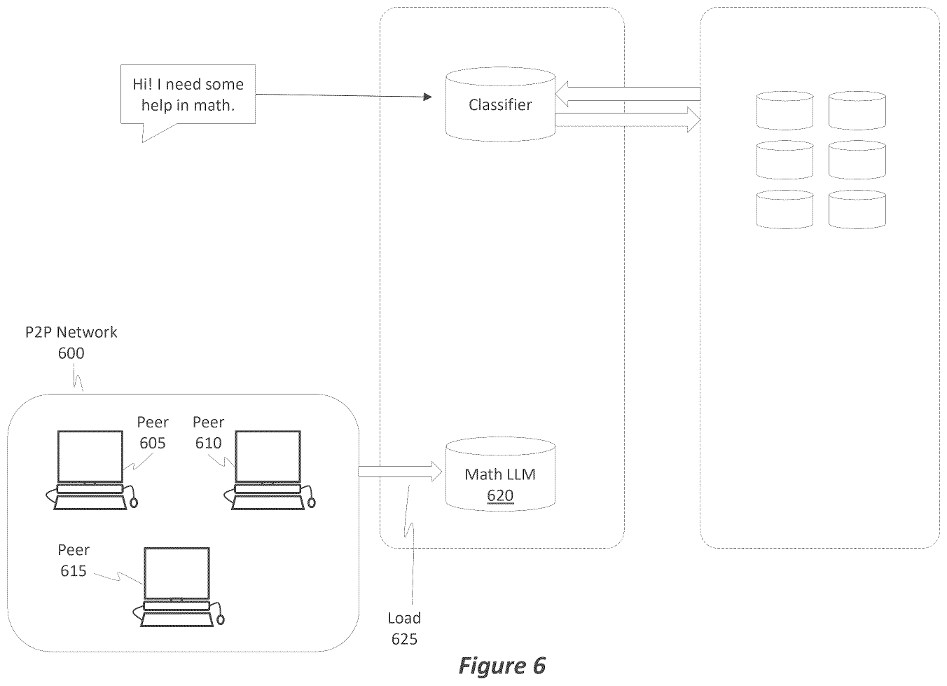

FIG. 6 shows a scenario where, instead of obtaining the context-specific LLM from the cloud, the embodiments obtain it from another node in a peer-to-peer network. In particular, FIG. 6 shows a peer-to-peer (P2P) network 600 that includes any number of peers, such as peer 605, peer 610, and peer 615. The current edge device is determined to not have a relevant context-specific LLM. As such, the embodiments search in the P2P network 600 to identify a peer that does have the relevant context-specific LLM. That model is then downloaded and loaded into memory, as shown by the context-specific math LLM 620 that is loaded into memory (e.g., load 625).

The example below demonstrates a potential approach to handling user question disambiguation through prompt engineering. Other options may also be available to manually select conversation context (e.g., a dropdown with conversation topic categories, etc.). When classifier 105 of FIG. 1 receives a question having a context not available in the local LLM library 130, classifier 105 can forward the question to a larger LLM running on the cloud or enterprise, which can answer such questions.

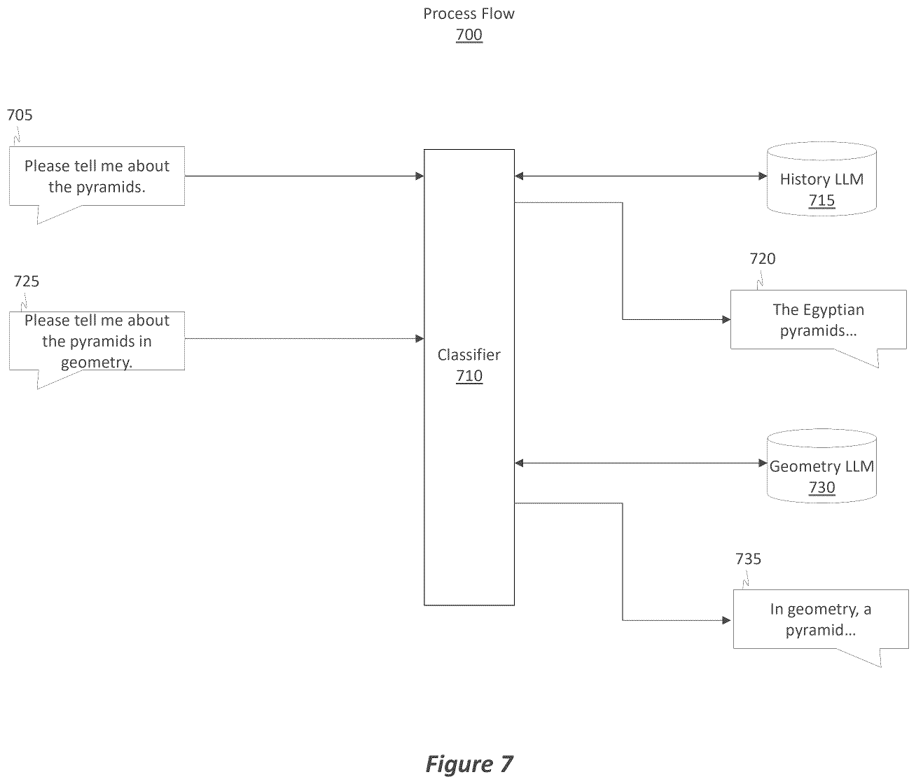

FIG. 7 shows an example process flow 700 in which disambiguation can be performed by the disclosed embodiments to obtain improved clarification regarding a context. In one example scenario, a user question 705 is received by classifier 710, which is representative of classifier 105 from FIG. 1. Classifier 710 estimates, predicts, or otherwise determines a context based on the language included in the user's question 705. Classifier 710 then selects a context-specific LLM (e.g., the history LLM 715) to answer the user's question 705, as shown by answer 720.

In this example scenario, however, the user meant a context that was different than the one the classifier 710 generated. The user recognized this difference based on the answer 720 provided by the history LLM 715. The history LLM 715 provided an answer relative to the Egyptian pyramids, whereas the user was interested in geometry-based pyramids.

As such, the user provides a follow-up user question 725, where this follow-up user question 725 includes additional clarifying language to help classifier 710 better determine the user's context. In response, classifier 710 then selects a different context-specific LLM (e.g., the geometry LLM 730) and provides a relevant answer 735.

In some scenarios, the disclosed classifier will generate a probability as to the accuracy of its determination of a user's context. If the probability is below a threshold level, then the classifier may issue one or more follow-up questions for the user to answer so the classifier can better determine the user's context. These follow-up questions can be raised prior to a context-specific LLM being loaded into memory.

The language in the user's answers to these follow-up questions can help the classifier select a best context-specific LLM to answer the user's questions. Thus, in some scenarios, probability values can be determined for the classifier's estimation of the user's context, and thresholds can be applied to determine whether the initial determination is sufficient or whether follow-up information from the user is warranted. In some scenarios, even if the probability meets or exceeds the threshold, the classifier can submit a statement to the user asking for verification. For instance, the classifier can state the following: “Just to make sure I am correctly understanding you, you would like to learn about pyramids in the context of Geometry.” Such a statement can help to elevate or increase the probability of being correct. If the initial determination is not correct, then the classifier can make a correction before any context-specific LLMs are loaded into memory, thus improving efficiency and performance.

One implementation disclosed herein prioritizes local, context-specific LLMs to reduce cloud LLM requests. The disclosed embodiments can also deploy enterprise-hosted models.

The embodiments can keep track of a user's request history and the frequency of requests sent to the cloud or to an enterprise LLM. This action can be done because sometimes a local context-specific LLM in the current category is not yet downloaded on the user's system. To avoid delays, rules and policies can be set up to allow a more frequently used context-specific LLM to be downloaded first if local space is available. If desired, the least frequently used context-specific LLM can be automatically deleted from local storage after a certain period of inactivity. This allows for automatic freeing up of local storage space. As a result, locally stored context-specific LLMs mainly handle user requests on the most frequent topic.

The disclosed modular LLM approach has the potential to be used in a way that allows multiple AI devices to be connected to a local peer network, as discussed previously in relation to FIG. 6. This arrangement can enable these devices to process requests using the context-specific LLMs already available on the local peer network. One benefit of this approach is that nodes can handle all the necessary requests locally within the immediate environment without the need to escalate to the enterprise or cloud LLMs.

While it is possible to solve the necessary space requirements in each local network device by installing sufficiently large storage devices, it might not be cost-effective. A simple example would be that a company with 5-100 workstations with “average” local storage capabilities must add storage to each workstation to store many LLMs locally on each device to reduce the number of cloud LLM request escalations. By utilizing a modular LLM approach and enabling peer AI request capability, the existing 5-100 workstations can typically accommodate sufficient local storage capacity to process user requests locally. For instance, each local device can store one or more context-specific LLMs, and each device can store a different set of context-specific LLMs. Thus, the entire P2P network can store a large aggregate of different context-specific LLMs. If one node does not have a relevant context-specific LLM, that node can easily and quickly obtain the relevant context-specific LLM from a neighboring node in the P2P network without having to escalate to a cloud request.

Another possible application of the modular LLM approach is to allow multiple AI application devices to be connected to a local enterprise cloud and attempt to process requests using existing models running on the local enterprise infrastructure. The advantage is that nodes can process all required topic requests in proximity without escalating to cloud LLMs.

Utilizing the local enterprise infrastructure can have several advantages. For instance, when specific context-specific LLMs are too large to run on any local client, the enterprise infrastructure can handle them. The proposed solution can also allow the gathering of data on context-specific LLM usage and can decide to activate some context-specific LLMs on the enterprise infrastructure when multiple nearby clients frequently use them. This approach would allow the clients to use their resources for other specialized models or to save energy costs. The “local model manager” can thus continue to use the local context-specific LLM if the user requires fast responses. The “enterprise model switcher engine” can work in close collaboration with the “local model selectors” and “model managers” to ensure a smooth transition to enterprise models versus local models.

Regarding the enterprise model switcher engine, this engine can include a telemetry engine that collects context-specific LLM utilization from local clients. The telemetry engine can feed a rule engine that can decide to instantiate specific context-specific LLMs locally. The enterprise model switcher engine can also send enterprise model instantiation messages to local engines.

Accordingly, the disclosed embodiments are directed to techniques for loading context-specific LLMs that leverage semantic routing. The embodiments can beneficially implement local model management, local peer LLM requests, and local-to-enterprise LLM requests. The embodiments are also beneficially directed to automatic local context-specific LLM clean-up actions based on when the context-specific LLM is not used for long periods. The embodiments can also leverage an enterprise model switcher that identifies opportunities to instantiate context-specific LLM s on the enterprise infrastructure and to advertise the information to local clients.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

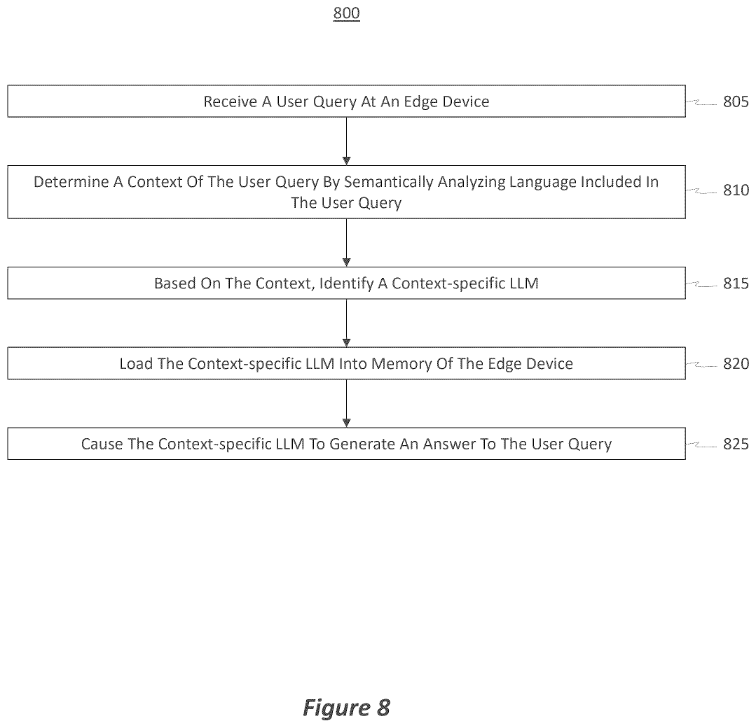

Attention will now be directed to FIG. 8, which illustrates a flowchart of an example method 800 for implementing a modular, context-specific LLM technique to answer user queries using LLMs at an edge device. Method 800 can be implemented within the architecture 100 of FIG. 1, and can be performed by the classifier 105, which may be executing on an edge device.

Method 800 includes an act (act 805) of receiving a user query at an edge device. For instance, the user query 120 of FIG. 1 can be representative. A persistent local storage (e.g., local storage 310 of FIG. 3) of the edge device includes a library (e.g., LLM library 130 of FIG. 1) of one or more context-specific large language models (LLMs) (e.g., the models 130A-D). Each context-specific LLM in the library is respectively trained on only a single corresponding context such that one or more different contexts are represented by the one or more context-specific LLMs. In some scenarios, the library includes a plurality of different context-specific LLMs.

Act 810 includes determining a context of the user query. This determination is performed by semantically analyzing language included in the user query.

Based on the context, act 815 includes identifying a context-specific LLM within the library. This context-specific LLM is trained to answer queries having contexts that are the same as the context of the user query.

Act 820 includes loading the context-specific LLM into memory of the edge device. Act 825 then includes causing the context-specific LLM to generate an answer to the user query.

In some implementations, the context of the user query is determined using an LLM, which is trained to identify contexts in user queries. Optionally, the classifier was previously loaded into the memory of the edge device.

In some implementations, prior to the context-specific LLM being loaded into the memory of the edge device, the classifier is unloaded from the memory. As another option, both the classifier and the context-specific LLM can simultaneously reside in the memory while the context-specific LLM generates the answer. Alternatively, the classifier can be unloaded from memory.

Method 800 can include additional acts. For instance, one act can include subsequently unloading the context-specific LLM from the memory. Another act can include receiving a second user query having a second context. Another act can include loading a second context-specific LLM into the memory. Here, the second context-specific LLM can be trained to answer queries having contexts that are the same as the second context. Yet another act can include causing the second context-specific LLM to generate a second answer for the second user query.

In some scenarios, the process of determining the context of the user query is performed using a classifier that is trained to identify contexts in user queries. In such scenarios, the embodiments can receive a second user query. The embodiments can then cause the classifier to semantically analyze the second user query. The classifier determines that a second context of the second user query is the same as the original context. The embodiments can then cause the context-specific LLM to generate a second answer to the second user query. Thus, the same context-specific LLM can answer multiple user queries provided they all relate to the same context.

In another scenario where determining the context of the user query is performed using a classifier that is trained to identify contexts in user queries, the embodiments may receive a second user query. The classifier can then be caused to semantically analyze the second user query, and the classifier may determine that a second context of the second user query is different than the original context. In response, the embodiments can unload the context-specific LLM from memory and load a second context-specific LLM into memory. Here, the second context-specific LLM is trained to answer queries having contexts that are the same as the second context. The embodiments can then cause the second context-specific LLM to generate a second answer to the second user query.

In scenarios where determining the context of the user query is performed using a classifier that is trained to identify contexts in user queries, the embodiments can receive a second user query. The embodiments can cause the classifier to semantically analyze the second user query, and the classifier may determine that a second context of the second user query is different than the original context. The embodiments can thus unload the context-specific LLM from memory. The embodiments can also determine that the library omits a second context-specific LLM that is trained to answer queries having contexts that are the same as the second context. In response, the embodiments may download the second context-specific LLM from an external source. The embodiments can then load the second context-specific LLM into memory and cause the second context-specific LLM to generate a second answer to the second user query.

In some scenarios, the external source is a peer-to-peer (P2P) network. In some scenarios, the external source is a cloud environment. Thus, in some scenarios, the external source is one of a peer-to-peer (P2P) network or a cloud environment.

It should be recognized how any of the disclosed features can be recited in combination with any of the other combined features. Thus, unless explicitly recited otherwise, features recited herein are combinable with other features, regardless of whether those features are illustrated in different figures or different portions of this disclosure.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, classifiers, and component are examples of terms that may refer to software objects or routines that execute on the computing system. The different components, modules, engines, services, and classifiers described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

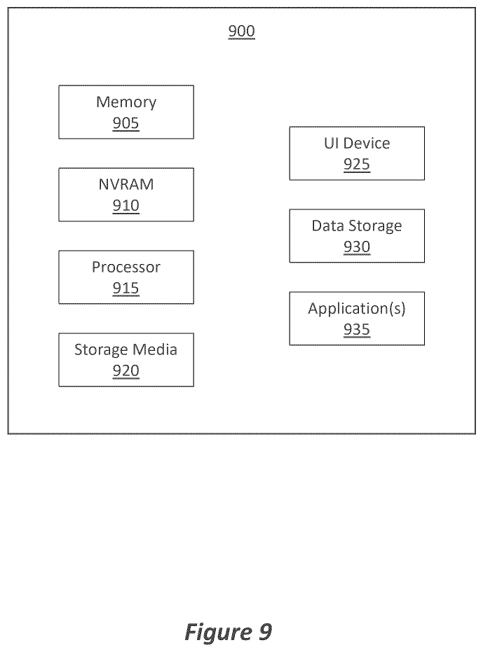

With reference briefly now to FIG. 9, any one or more of the entities disclosed, or implied, by the Figures and/or elsewhere herein, may take the form of, or include, or be implemented on, or hosted by, a physical computing device, one example of which is denoted at 900. This example device can be in the form of the edge device 105A of FIG. 1. Also, where any of the aforementioned elements comprise or consist of a virtual machine (VM), that VM may constitute a virtualization of any combination of the physical components disclosed in FIG. 9.

In the example of FIG. 9, the physical computing device 900 includes a memory 905 which may include one, some, or all, of random access memory (RAM), non-volatile memory (NVM) 910 such as NVRAM for example, read-only memory (ROM), and persistent memory, one or more hardware processors 915, non-transitory storage media 920, UI device 925, and data storage 930. One or more of the memory 905 of the physical computing device 900 may take the form of solid-state device (SSD) storage. Also, one or more applications 935 may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 900 may also be representative of an edge system, a cloud-based system, a datacenter or portion thereof, or other system or entity.

The disclosed embodiments can be implemented in numerous different ways, as described in the various different clauses recited below.

Clause 1. A method comprising: receiving a user query at an edge device, wherein a persistent local storage of the edge device includes a library of one or more context-specific large language models (LLMs), and wherein each context-specific LLM in the library is respectively trained on only a single corresponding context such that one or more different contexts are represented by the one or more context-specific LLMs; determining a context of the user query by semantically analyzing language included in the user query; based on the context, identifying a context-specific LLM within the library, wherein the context-specific LLM is trained to answer queries having contexts that are the same as the context of the user query; loading the context-specific LLM into memory of the edge device; and causing the context-specific LLM to generate an answer to the user query.

Clause 2. The method of clause 1, wherein the context of the user query is determined using a classifier, which is trained to identify contexts in user queries, and wherein the classifier was previously loaded into the memory of the edge device.

Clause 3. The method of clause 2, wherein, prior to the context-specific LLM being loaded into the memory of the edge device, the classifier is loaded from the memory.

Clause 4. The method of clause 2, wherein both the classifier and the context-specific LLM simultaneously reside in the memory while the context-specific LLM generates the answer.

Clause 5. The method of clause 1, wherein the method further includes: subsequently unloading the context-specific LLM from the memory; receiving a second user query having a second context; loading a second context-specific LLM into the memory, the second context-specific LLM being trained to answer queries having contexts that are the same as the second context; and causing the second context-specific LLM to generate a second answer for the second user query.

Clause 6. The method of clause 1, wherein determining the context of the user query is performed using a classifier that is trained to identify contexts in user queries, and wherein the method further includes: receiving a second user query; causing the classifier to semantically analyze the second user query, wherein the classifier determines that a second context of the second user query is the same as said context; and causing the context-specific LLM to generate a second answer to the second user query.

Clause 7. The method of clause 1, wherein determining the context of the user query is performed using a classifier that is trained to identify contexts in user queries, and wherein the method further includes: receiving a second user query; causing the classifier to semantically analyze the second user query, wherein the classifier determines that a second context of the second user query is different than said context; unloading the context-specific LLM from memory; loading a second context-specific LLM into memory, wherein the second context-specific LLM is trained to answer queries having contexts that are the same as the second context; and causing the second context-specific LLM to generate a second answer to the second user query.

Clause 8. The method of clause 1, wherein the library includes a plurality of different context-specific LLMs.

Clause 9. The method of clause 1, wherein determining the context of the user query is performed using a classifier that is trained to identify contexts in user queries, and wherein the method further includes: receiving a second user query; causing the classifier to semantically analyze the second user query, wherein the classifier determines that a second context of the second user query is different than said context; unloading the context-specific LLM from memory; determining that the library omits a second context-specific LLM that is trained to answer queries having contexts that are the same as the second context; downloading the second context-specific LLM from an external source; loading the second context-specific LLM into the memory; and causing the second context-specific LLM to generate a second answer to the second user query.

Clause 10. The method of clause 9, wherein the external source is one of a peer-to-peer (P2P) network or a cloud environment.

Clause 11. One or more hardware storage devices that store instructions that are executable by one or more processors of an edge device to cause the one or more processors to: receive a user query at the edge device, wherein the one or more hardware storage devices of the edge device include a library of one or more context-specific large language models (LLMs), and wherein each context-specific LLM in the library is respectively trained on only a single corresponding context such that one or more different contexts are represented by the one or more context-specific LLMs; determine a context of the user query by semantically analyzing language included in the user query; based on the context, identify a context-specific LLM within the library, wherein the context-specific LLM is trained to answer queries having contexts that are the same as the context of the user query; load the context-specific LLM into memory of the edge device; and cause the context-specific LLM to generate an answer to the user query.

Clause 12. The one or more hardware storage devices of clause 11, wherein the context of the user query is determined using a classifier, which is trained to identify contexts in user queries, and wherein the classifier was previously loaded into the memory of the edge device.

Clause 13. The one or more hardware storage devices of clause 12, wherein, prior to the context-specific LLM being loaded into the memory of the edge device, the classifier is loaded from the memory.

Clause 14. The one or more hardware storage devices of clause 12, wherein both the classifier and the context-specific LLM simultaneously reside in the memory while the context-specific LLM generates the answer.

Clause 15. The one or more hardware storage devices of clause 11, wherein the instructions are further executable to cause the one or more processors to: subsequently unload the context-specific LLM from the memory; receive a second user query having a second context; load a second context-specific LLM into the memory, the second context-specific LLM being trained to answer queries having contexts that are the same as the second context; and cause the second context-specific LLM to generate a second answer for the second user query.

Clause 16. The one or more hardware storage devices of clause 11, wherein determining the context of the user query is performed using a classifier that is trained to identify contexts in user queries, and wherein the instructions are further executable to cause the one or more processors to: receive a second user query; cause the classifier to semantically analyze the second user query, wherein the classifier determines that a second context of the second user query is the same as said context; and cause the context-specific LLM to generate a second answer to the second user query.

Clause 17. The one or more hardware storage devices of clause 11, wherein determining the context of the user query is performed using a classifier that is trained to identify contexts in user queries, and wherein the instructions are further executable to cause the one or more processors to: receive a second user query; cause the classifier to semantically analyze the second user query, wherein the classifier determines that a second context of the second user query is different than said context; unload the context-specific LLM from memory; load a second context-specific LLM into memory, wherein the second context-specific LLM is trained to answer queries having contexts that are the same as the second context; and cause the second context-specific LLM to generate a second answer to the second user query.

Clause 18. The one or more hardware storage devices of clause 11, wherein determining the context of the user query is performed using a classifier that is trained to identify contexts in user queries, and wherein the instructions are further executable to cause the one or more processors to: receive a second user query; cause the classifier to semantically analyze the second user query, wherein the classifier determines that a second context of the second user query is different than said context; unload the context-specific LLM from memory; determine that the library omits a second context-specific LLM that is trained to answer queries having contexts that are the same as the second context; download the second context-specific LLM from an external source; load the second context-specific LLM into the memory; and cause the second context-specific LLM to generate a second answer to the second user query.

Clause 19. The one or more hardware storage devices of clause 18, wherein the external source is one of a peer-to-peer (P2P) network or a cloud environment.

Clause 20. An edge device comprising: one or more processors; and one or more hardware storage devices that store instructions that are executable by the one or more processors to cause the edge device to: receive a user query, wherein the one or more hardware storage devices include a library of one or more context-specific large language models (LLMs), and wherein each context-specific LLM in the library is respectively trained on only a single corresponding context such that one or more different contexts are represented by the one or more context-specific LLMs; determine a context of the user query by semantically analyzing language included in the user query; based on the context, identify a context-specific LLM within the library, wherein the context-specific LLM is trained to answer queries having contexts that are the same as the context of the user query; load the context-specific LLM into memory of the edge device; and cause the context-specific LLM to generate an answer to the user query.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
receiving a user query at an edge device, wherein a persistent local storage of the edge device includes a library of one or more context-specific large language models (LLMs), and wherein each context-specific LLM in the library is respectively trained on only a single corresponding context such that one or more different contexts are represented by the one or more context-specific LLMs;
determining a context of the user query by semantically analyzing language included in the user query;
based on the context, identifying a context-specific LLM within the library, wherein the context-specific LLM is trained to answer queries having contexts that are the same as the context of the user query;
loading the context-specific LLM into memory of the edge device; and
causing the context-specific LLM to generate an answer to the user query.

2. The method of claim 1, wherein the context of the user query is determined using a classifier, which is trained to identify contexts in user queries.

3. The method of claim 2, wherein, prior to the context-specific LLM being loaded into the memory of the edge device, the classifier is loaded from the memory.

4. The method of claim 2, wherein both the classifier and the context-specific LLM simultaneously reside in the memory while the context-specific LLM generates the answer.

5. The method of claim 1, wherein the method further includes:
subsequently unloading the context-specific LLM from the memory;
receiving a second user query having a second context;
loading a second context-specific LLM into the memory, the second context-specific LLM being trained to answer queries having contexts that are the same as the second context; and
causing the second context-specific LLM to generate a second answer for the second user query.

6. The method of claim 1, wherein determining the context of the user query is performed using a classifier that is trained to identify contexts in user queries, and wherein the method further includes:
receiving a second user query;
causing the classifier to semantically analyze the second user query, wherein the classifier determines that a second context of the second user query is the same as said context; and
causing the context-specific LLM to generate a second answer to the second user query.

7. The method of claim 1, wherein determining the context of the user query is performed using a classifier that is trained to identify contexts in user queries, and wherein the method further includes:
receiving a second user query;
causing the classifier to semantically analyze the second user query, wherein the classifier determines that a second context of the second user query is different than said context;
unloading the context-specific LLM from memory;
loading a second context-specific LLM into memory, wherein the second context-specific LLM is trained to answer queries having contexts that are the same as the second context; and
causing the second context-specific LLM to generate a second answer to the second user query.

8. The method of claim 1, wherein the library includes a plurality of different context-specific LLMs.

9. The method of claim 1, wherein determining the context of the user query is performed using a classifier that is trained to identify contexts in user queries, and wherein the method further includes:
receiving a second user query;
causing the classifier to semantically analyze the second user query, wherein the classifier determines that a second context of the second user query is different than said context;
unloading the context-specific LLM from memory;
determining that the library omits a second context-specific LLM that is trained to answer queries having contexts that are the same as the second context;
downloading the second context-specific LLM from an external source;
loading the second context-specific LLM into the memory; and
causing the second context-specific LLM to generate a second answer to the second user query.

10. The method of claim 9, wherein the external source is one of a peer-to-peer (P2P) network or a cloud environment.

11. One or more hardware storage devices that store instructions that are executable by one or more processors of an edge device to cause the one or more processors to:
receive a user query at the edge device, wherein the one or more hardware storage devices of the edge device include a library of one or more context-specific large language models (LLMs), and wherein each context-specific LLM in the library is respectively trained on only a single corresponding context such that one or more different contexts are represented by the one or more context-specific LLMs;
determine a context of the user query by semantically analyzing language included in the user query;
based on the context, identify a context-specific LLM within the library, wherein the context-specific LLM is trained to answer queries having contexts that are the same as the context of the user query;
load the context-specific LLM into memory of the edge device; and
cause the context-specific LLM to generate an answer to the user query.

12. The one or more hardware storage devices of claim 11, wherein the context of the user query is determined using a classifier, which is trained to identify contexts in user queries, and wherein the classifier was previously loaded into the memory of the edge device.

13. The one or more hardware storage devices of claim 12, wherein, prior to the context-specific LLM being loaded into the memory of the edge device, the classifier is loaded from the memory.

14. The one or more hardware storage devices of claim 12, wherein both the classifier and the context-specific LLM simultaneously reside in the memory while the context-specific LLM generates the answer.

15. The one or more hardware storage devices of claim 11, wherein the instructions are further executable to cause the one or more processors to:
subsequently unload the context-specific LLM from the memory;
receive a second user query having a second context;
load a second context-specific LLM into the memory, the second context-specific LLM being trained to answer queries having contexts that are the same as the second context; and
cause the second context-specific LLM to generate a second answer for the second user query.

16. The one or more hardware storage devices of claim 11, wherein determining the context of the user query is performed using a classifier that is trained to identify contexts in user queries, and wherein the instructions are further executable to cause the one or more processors to:
receive a second user query;
cause the classifier to semantically analyze the second user query, wherein the classifier determines that a second context of the second user query is the same as said context; and
cause the context-specific LLM to generate a second answer to the second user query.

17. The one or more hardware storage devices of claim 11, wherein determining the context of the user query is performed using a classifier that is trained to identify contexts in user queries, and wherein the instructions are further executable to cause the one or more processors to:
receive a second user query;
cause the classifier to semantically analyze the second user query, wherein the classifier determines that a second context of the second user query is different than said context;
unload the context-specific LLM from memory;
load a second context-specific LLM into memory, wherein the second context-specific LLM is trained to answer queries having contexts that are the same as the second context; and
cause the second context-specific LLM to generate a second answer to the second user query.

18. The one or more hardware storage devices of claim 11, wherein determining the context of the user query is performed using a classifier that is trained to identify contexts in user queries, and wherein the instructions are further executable to cause the one or more processors to:
receive a second user query;
cause the classifier to semantically analyze the second user query, wherein the classifier determines that a second context of the second user query is different than said context;
unload the context-specific LLM from memory;
determine that the library omits a second context-specific LLM that is trained to answer queries having contexts that are the same as the second context;
download the second context-specific LLM from an external source;
load the second context-specific LLM into the memory; and
cause the second context-specific LLM to generate a second answer to the second user query.

19. The one or more hardware storage devices of claim 18, wherein the external source is one of a peer-to-peer (P2P) network or a cloud environment.

20. An edge device comprising:
one or more processors; and
one or more hardware storage devices that store instructions that are executable by the one or more processors to cause the edge device to:
receive a user query, wherein the one or more hardware storage devices include a library of one or more context-specific large language models (LLMs), and wherein each context-specific LLM in the library is respectively trained on only a single corresponding context such that one or more different contexts are represented by the one or more context-specific LLMs;
determine a context of the user query by semantically analyzing language included in the user query;
based on the context, identify a context-specific LLM within the library, wherein the context-specific LLM is trained to answer queries having contexts that are the same as the context of the user query;
load the context-specific LLM into memory of the edge device; and
cause the context-specific LLM to generate an answer to the user query.
